(19) United States
(12) Patent Application Publication
(10) Pub. No.: US 2009/0161367 A1
(43) Pub. Date: Jun. 25, 2009

(54) LUMINAIRE REFLECTOR

(76) Inventor: James G. VANDEN EYNDEN, Hamilton, OH (US)

Correspondence Address: HASSE & NESBITT LLC, 8837 CHAPEL SQUARE DRIVE, SUITE C, CINCINNATI, OH, 45249, US

(21) Appl. No.: 11/962,557

(22) Filed: Dec. 21, 2007

(51) Int. Cl. F21V 7/04

(52) U.S. Cl. 362/297

(57) ABSTRACT

A reflector for a luminaire comprising a plurality of reflective panels retained in a three-dimensional concave reflector shape. The reflector shape defines a first opening for a light source and a second opening for emitting light in a predetermined distribution pattern. Each of the reflective panels has an inwardly-facing smooth reflective surface between the light source opening and the light emitting opening. The light emitting opening plane is perpendicular to nadir. The reflective panels are curved inward in the direction of nadir adjacent to the light emitting opening to produce a secondary reflective surface for a portion of light from the light source.

### FIELD OF THE INVENTION

The present invention relates generally to luminaires and, more particularly, to three dimensional reflectors for luminaires that more efficiently produce a desired light distribution pattern on a surrounding surface.

### BACKGROUND OF THE INVENTION

Luminaires are designed to produce a predetermined light distribution pattern in an area to be illuminated, such as in parking lots, along roadways, or in other areas requiring broad or focused illumination of a surface. Luminaires generally include a housing or enclosure that supports a lamp socket, a high-intensity lamp source mounted in the lamp socket, a light reflector mounted behind and/or around the lamp source, and other electrical hardware necessary to energize the lamp source. The illumination pattern created by the luminaire is generally defined by the shape of the light reflector mounted in the luminaire, as well as the position of the light source relative to the reflector. The reflector can form a partial enclosure about the source of light so that the inner surfaces of the reflector direct reflected light through an opening formed in a lower portion of the luminaire housing.

In the past, one-piece reflectors have been fabricated by molding or otherwise forming a flat piece of metal or other suitable reflective material into a desired reflector shape. The reflector can be made by forming a sheet of reflective material between male and female dies that have cooperating three-dimensional surfaces defining the reflector shape. Alternatively, the reflector may be formed by hydroforming the sheet of reflective material over a three-dimensional male form that defines the reflector shape. In another method, the reflector may be spun by contouring a sheet of reflective material over a revolving male mandrel with a pressure tool to conform the sheet to the shape of the mandrel. In yet another method of fabricating reflectors, the sheet of reflective material may be formed using a press brake or other forming machine that successively bends the sheet along predetermined fold lines into a series of planar facets that approximate a desired curved surface of the reflector.

Reflectors have also been fabricated from multiple sheets of reflective material that have been individually formed and then assembled together to produce a desired reflector shape. The individual parts of the multi-component reflector have either been joined together through fastening hardware, or other suitable structures, prior to mounting the assembled reflector in a luminaire housing, or the reflector components have been mounted individually within the luminaire housing to form the three-dimensional reflector shape within the housing.

More recently, as described in U.S. Pat. No. 6,464,378, reflectors have been fabricated from a single sheet of reflective material that has been punched out in a single hit die press, or other cutting operation, to form a series of integral reflective panels. The reflective panels are adapted to be joined together so that each of the panels can be folded by hand into an edge-abutting relationship with an adjacent panel to form a predetermined three-dimensional reflector shape. The sheet of material is relatively thin to allow one or more of the panels to be curved by hand to define curved reflective surfaces, which can be joined to adjacent panels through perforated fold lines. These reflectors are efficient to make and store, and can be easily assembled into a three-dimensional shape at an assembly site or in the field.

In most outdoor lighting installations, a plurality of luminaires are mounted onto light poles of generally standard height to provide a particular ground illumination pattern. The illumination needs of a particular parking lot, roadway or other outdoor area are met by positioning the plurality of mounted luminaires in a spaced relationship about the surface to be illuminated. Oftentimes, in a lighting installation, the spacing of the mounting poles may cause the luminaires to throw light beyond the area of need, and/or produce an uneven illumination of the ground, road or parking area. This is particularly the case with traditional IESNA Type V luminaire reflectors which produce a circular symmetrical light distribution pattern. When a plurality of luminaires having these conventional reflectors are used to illuminate a large surface area, such as a parking lot, dark areas, or corners, are formed between the illumination areas of adjacent luminaires. In many applications, a higher intensity or higher wattage light source is required to compensate for the loss of light in these dark areas, or because of uneven lighting between the luminaires. Alternatively, additional luminaires and mounting poles may be required to eliminate the “dark areas” and provide adequate, uniform lighting to all of the surface area.

Accordingly, it is desirable to have a luminaire assembly that provides a more even and effective distribution of a majority of the light that is emitted from a lamp to light particular outdoor areas. Additionally, it is desirable to have a luminaire reflector that provides a larger, more effective, light distribution pattern without increasing the lumens or wattage of the light source. Further, it is desirable to have a luminaire reflector that provides a square light distribution pattern in order to eliminate dark corners within the illumination area. Furthermore, it is desirable to have a luminaire reflector that provides a more efficient light distribution pattern while also minimizing the glare produced by the luminaire. Still further, it is desirable to have a high efficiency luminaire reflector that can be rapidly and consistently formed from one or more sheets of reflective material. Additionally, it is desirable to have a high efficiency luminaire reflector that allows greater spacing between adjacent light poles while maintaining the same level of illumination or, alternatively, that provides an equal level of illumination with existing light pole spacing but using lower wattage light sources to reduce the overall energy consumption.

### SUMMARY OF THE INVENTION

In response to these needs, the present invention provides a reflector for a luminaire in which the reflective panels are configured to provide greater, more uniform illumination from a designated wattage lamp source. In particular, the present invention provides a reflector for a luminaire that has a light source securable therein. The reflector comprises a plurality of reflective panels retained in a three-dimensional concave reflector shape. The reflector shape defines a first opening for the light source and a second opening for emitting light in a predetermined distribution pattern. Each of the reflective panels has an inwardly-facing, smooth and continuous reflective surface between the light source opening and the light emitting opening. The plane of the light emitting opening is perpendicular to nadir. The reflective panels are curved inward in the direction of nadir adjacent to the light emitting opening to increase the distance of the reflected light beam.

Additionally, the present invention provides a luminaire assembly comprising a luminaire housing and a reflector mounted within the luminaire housing. The reflector comprises a plurality of reflective panels retained in a three-dimensional concave reflector shape that defines a light source opening and a light emitting opening for emitting light in a predetermined distribution pattern. The light emitting opening occupies a plane perpendicular to nadir. The reflective panels are curved in the direction of nadir to form a reduced diameter at the light emitting opening. The luminaire assembly may also include a light source socket mounted to the reflector. A light source is attached within the socket for emitting light upon energizing the source. The lamp socket is mounted so as to position the light source within the apex of the reflector.

### BRIEF DESCRIPTION OF THE DRAWINGS

The accompanying drawings, which are incorporated into and constitute a part of this specification, illustrate embodiments of the invention and, together with a general description of the invention given above, and the detailed description of the embodiments given below, serve to explain the principles of the invention.

FIG. 1 is a bottom perspective view taken from a light emitting end, illustrating a preferred embodiment of the reflector of the present invention, installed in a luminaire housing;

FIG. 2 is a cross-sectional view of the reflector, taken along lines 2-2 in FIG. 1;

FIG. 3 is a plan view of a preformed sheet that can be folded to form the assembled reflector shown in FIG. 1;

FIG. 4 is a bottom view of the reflector taken from the light emitting end;

FIG. 5 is a cross-sectional view of the reflector showing a light source within the reflector and the reflective light pattern generated by the light source and reflector;

FIG. 6 is a simplified, sectional view of a reflector and light source according to the present invention, illustrating the toed-in lower reflector edge and angle of reflected light exiting the reflector opening;

FIG. 7 is a simplified, sectional view of a conventional reflector and light source illustrating the angle of reflected light exiting the reflector opening;

FIG. 8 is an iso-footcandle plot showing the light distribution pattern for a luminaire having a 120,000 lumen light source and the reflector of the present invention;

FIG. 9 is an iso-footcandle plot showing the light distribution pattern for a conventional IESNA Type V reflector luminaire having a 120,000 lumen light source;

FIG. 10 is a side view showing the ornamental appearance of the reflector of FIG. 1, with the front, back and other side view being the same;

FIG. 11 is a top view of the reflector of FIG. 10; and

FIG. 12 is bottom view of FIG. 10 looking up from the light emitting end, showing the plurality of reflective panels in the reflector.

### DETAILED DESCRIPTION OF THE INVENTION

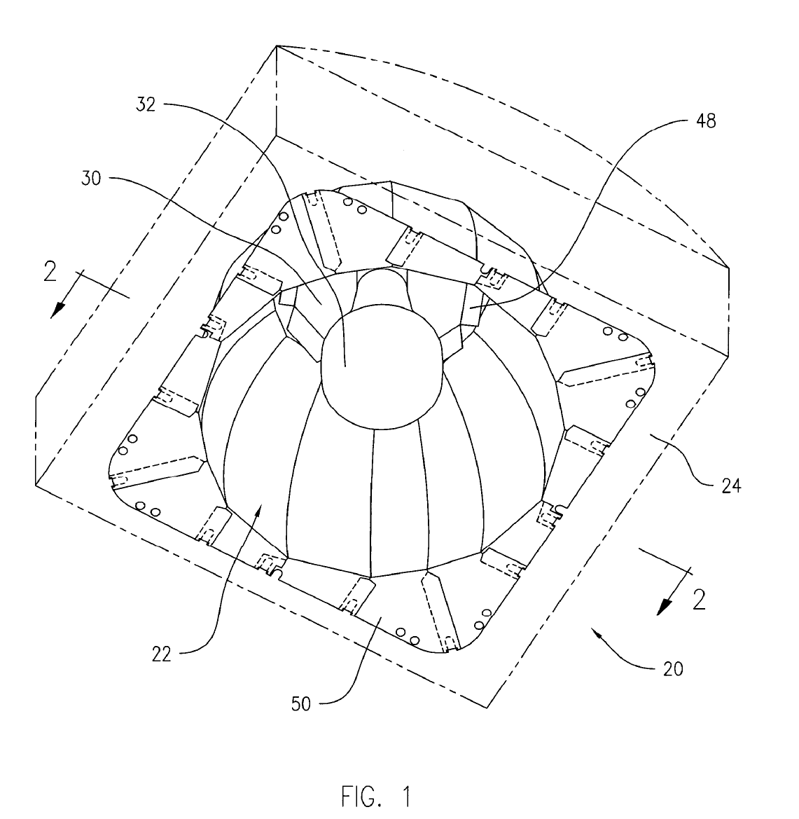

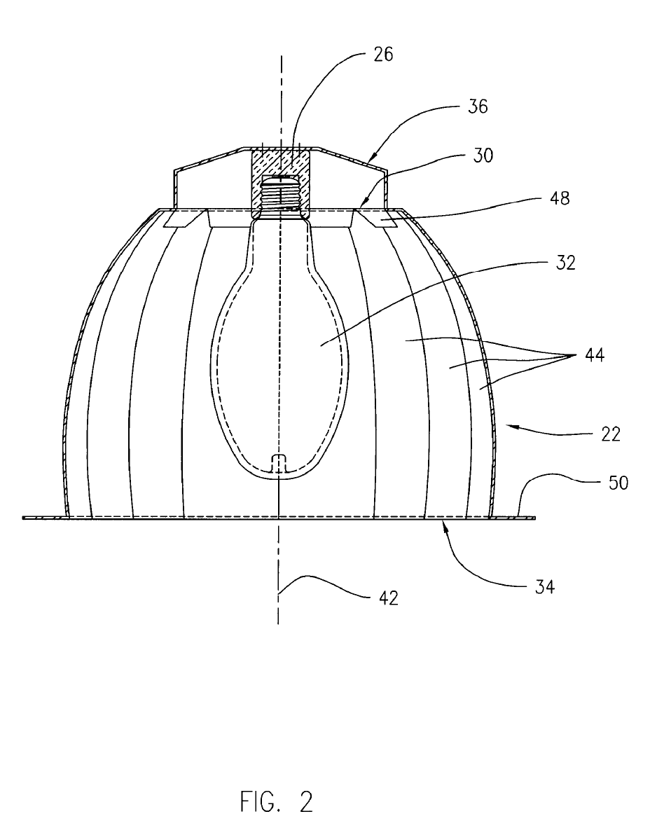

Referring now to the drawing figures, in which like numerals indicate like elements throughout the views, FIGS. 1 and 2 disclose a luminaire 20 having a self-standing reflector 22. Self-standing reflector 22 may be installed within a housing 24 of luminaire 20 by any of a variety of means well known in the art. A light source socket 26 is disposed proximate a top opening 30 of reflector 22. A light source, such as a lamp 32, is mounted in socket 26 for emitting light from an opening 34 in the lower portion of the reflector 22. Lamp 32 is preferably a high intensity discharge (HID) lamp suitable for use in lighting outdoor areas such as, for example, parking lots. A bracket 36 supports the light source socket 26 proximate the top opening 30 in the reflector 22. Light source socket 26 is positioned so that when lamp 32 is inserted into the socket the lamp extends through top opening 30 and into the inner space or cavity of reflector 22. Bracket 36 includes legs that descend from a central base and are affixed or secured to reflector 22. Light source socket 26 is mounted to the base of bracket 36 through a suitable fastener (not shown) as is well known in the art. Socket 26 is mounted to bracket 36 so that the longitudinal axis of the light source secured within the socket is aligned generally along a centralized optical axis or nadir 42 of the reflector. Aligning the longitudinal axis of the light source 32 with nadir 42 enables a symmetrical light pattern to be produced on the surface below the luminaire. A lens (not shown) can be mounted on the underside of the luminaire housing to cover openings in the housing and reflector.

Reflector 22 is positioned about lamp 32 to direct or reflect light in a predetermined light distribution pattern through reflector opening 34. As those of ordinary skill in the art will appreciate, luminaire housing 24 can be formed in a variety of shapes and sizes depending upon the particular lighting application or need. Luminaire 20 is typically mounted on a pole or other supporting structure to raise the luminaire assembly sufficiently above the surrounding surface to provide a broad light distribution pattern on the surface. It will be appreciated that luminaire 20 can also include a transformer and other electrical hardware for connecting the luminaire to a source of power and for energizing lamp 32 via suitable wiring connected to socket 26. A typical luminaire assembly is described in U.S. Pat. No. 6,464,378, which is hereby incorporated herein by reference.

Luminaire reflector 22 is formed from a unitary sheet of reflective material in a laser cutting operation, or other similar type of cutting method known in the art. The sheet of reflective material may be polished, anodized aluminum (also known as “specular aluminum”) semi-specular aluminum, or another type of reflective material that has the desired reflective and other structural properties for a reflector. A preferred material for the reflective sheet is Alanod Miro-4, a highly specular anodized aluminum having a minimum 95% reflectance, which is available from ALANOD Aluminum-Veredlung GmbH & Co. KG. The reflective sheet preferably has a thickness of approximately 0.02 inch to enable the sheet to be folded and curved by hand, or a manually-operated tool, into a desired three-dimensional reflector shape. To form a reflector, the sheet of reflective material is cut into a desired pattern in a single dimension. Following the cutting operation, multiple, unassembled reflectors may be stacked and stored easily in the single dimension configuration.

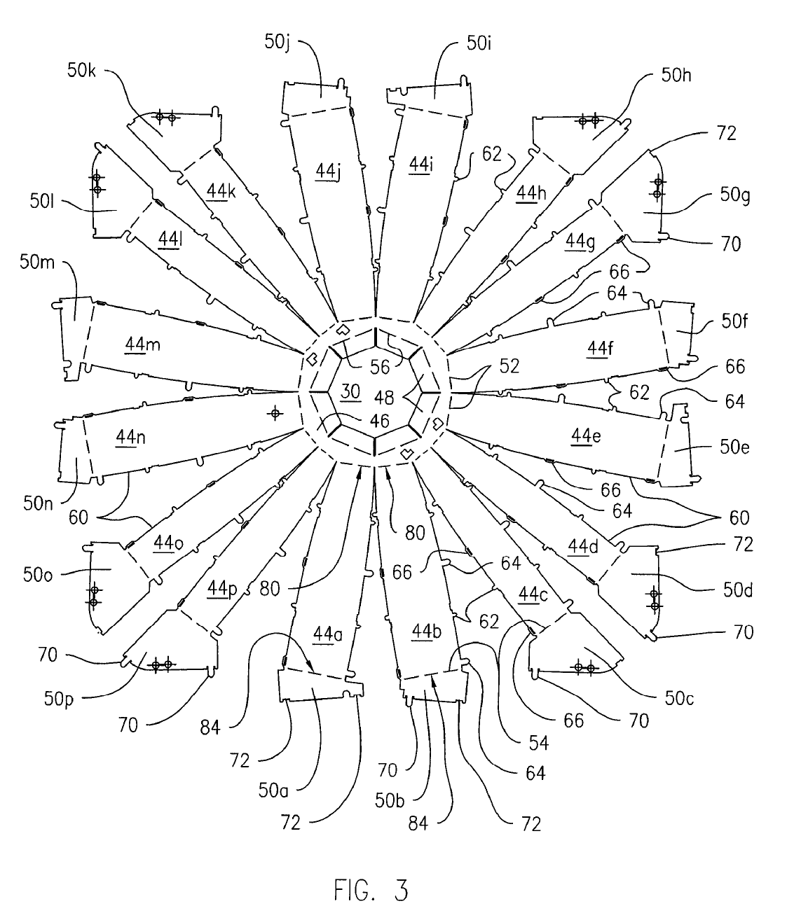

As shown in FIG. 3, in the preferred embodiment the sheet of reflective material is cut to form a pattern having a plurality of planar integral panels 44 (individually labeled as 44a-44p). Each of the panels extends from a center support collar 46 having opening 30 formed therein. A plurality of collar segments 48 extend around the periphery of opening 30. A distal end of each integral panel 44 forms a mounting flange 50 (individually labeled as 50a-50p). One or more openings or slots 52 are located at the junctions between the panels 44 and the support collar 46. Slots 52 extend through the thickness of the reflective sheet to facilitate manual folding of the sheet along the line formed by the slots. Similarly, openings or slots 54 are located between each panel 44 and mounting flange 50 to enable the mounting flanges to be folded relative to the panels, and slots 56 are formed between support collar 46 and collar segments 48 to facilitate folding of the segments relative to the collar. While elongated slots 52, 54 and 56 are shown as forming the fold lines in FIG. 3, it will be appreciated by those of ordinary skill in the art that fold lines in the reflector could also be formed by smaller circular apertures, slits, score lines, or other bendable or yielding structures formed in the unitary, single-piece reflective sheet, without departing from the spirit and scope of the present invention. Additionally, while pre-formed fold lines are preferred, it is contemplated that other structures may be formed into the sheet of reflective material, or attached thereto upon folding of the sheet, to define predetermined fold lines or lines of bending in the reflective sheet.

Panels 44, mounting flanges 50, center support ring 46 and collar segments 48 generally lie in a common plane after the reflector pattern is cut from the reflective sheet. In the illustrated embodiment, panels 44 are configured in different widths along the base (the portion proximate the mounting flanges), depending upon the light-reflecting performance desired from the panel. Each panel 44 is formed with a pair of spaced, elongated, non-linear free edges 60 that are adapted to abut the non-linear free edges 60 of adjacent panels when the panels are folded to form the assembled reflector 22 shown in FIGS. 1 and 2. Each panel 44 has at least one and, more typically, a plurality of positioning tabs 62 extending outwardly from panel edges 60 to aid in aligning, positioning, and holding together the abutting panel edges. The plurality of tabs 62 cooperate with the edges 60 of the panels to form a panel lock, which is intended to prevent the folded reflector panels from separating during normal handling and use. Additional locking means include the combination of a locking tab 64 on one panel edge 60 that engages a slot 66 along the edge 60 of an abutting panel. In FIG. 3, a tab 64 and slot 66 locking means is shown along the midsection of panel edges 60, and also along the lower edges of the panels 44 adjacent the mounting flanges 50.

In addition to the locking members on panels 44, mounting flanges 50 include tabs 70 and notches 72 to hold the mounting flanges together within the assembled reflector. A tab 70 and notch 72 is formed in a spaced relationship along the outer edge of each of the flanges 50b-50o to allow the tab from one flange to mate with the notch of the adjacent flange when the flanges are brought together during folding. Mounting flange 50a is the initial flange that is bent during folding of the reflective sheet into an assembled reflector. As such, mounting flange 50a includes a pair of notches 72 that are spaced apart along the outer edge of the mounting flange, so that the notches may be brought into engagement with tabs from both adjacent mounting flanges (50b and 50p) during folding, to lock the adjacent flanges to the initial flange 50a. Similarly, mounting flange 50p has a pair of tabs 70 that are spaced apart along the outer edge of the mounting flange. Mounting flange 50p is the last flange to be folded during the reflector assembly. The additional tab 70 on the outer edge of mounting flange 50p enables the flange to be joined to notches 72 on both of the adjacent flanges, i.e. the immediately prior folded mounting flange 50o and the initially folded mounting flange 50a.

To assemble a three-dimensional reflector 22, a first panel 44a of the reflective sheet shown in FIG. 3, is folded along a fold line 80. Fold line 80 is formed by slots 52 between the panel 44a and support collar 46. As the panel 44a is folded, the midsection of the planar surface of the panel is bowed outward in a direction away from nadir 42 in a parabolic-like contour. After the planar panel is bowed outward to a maximum radius, a lower edge portion of the panel is curved inward towards nadir. The panel is shaped such that the lower edge portion (adjacent mounting flange 50a) curves from the point of greatest outward bowing (i.e. maximum radius) inward towards nadir. The shaping of panel 44a produces a folded panel having a smooth, continuously curving, and inwardly reflective surface. After the first panel 44a is shaped, the attached mounting flange 50a is folded in an outward direction along a fold line 84 into a mounting-flange forming position. In the mounting flange forming position, the mounting flange 50a lies in a plane perpendicular to nadir 42. Next, an adjacent panel 44b is folded relative to collar 46 along a fold line 80. As panel 44b is folded, the planar surface of the panel is shaped in a continuously curving manner, similar to the first panel 44a, so that the resulting panel is bowed outward to a maximum radius through a midsection of the panel, and back inward towards nadir adjacent the lower edge of the panel.

As panel 44b is folded and shaped, the panel is brought into an edge abutting relationship with the adjacent first panel 44a. The positioning tabs 62 along the free edges of the panels 44a and 44b are brought together so that the positioning tabs of each curved panel overlie the abutting marginal edge of the adjacent curved panel to hold the free edges of the panels together in an abutting relationship. Additionally, a locking tab 64 on one of the panel edges 60 is brought into engagement with, and bent into and through a slot 66 on the adjacent panel edge to further lock the abutting panels together. In the embodiment shown in FIG. 3, a locking tab 64 and slot 66 are located at a midpoint along the longitudinal free edges of the panels. This location of the locking tab and slot coincides with the outwardly bowed midsection of the panels to aid in securing the panels together at the outward curve of the panels, and prevent separation of the assembled reflector. An additional locking tab 64 and slot 66 pair is located adjacent the lower, inwardly curved edge of the panels 44. When engaged, the lower locking tab and slot pair 64, 66 secures the lower, toed-in edge of the panels together, and prevents outward movement and separation of the panels at the base of the reflector.

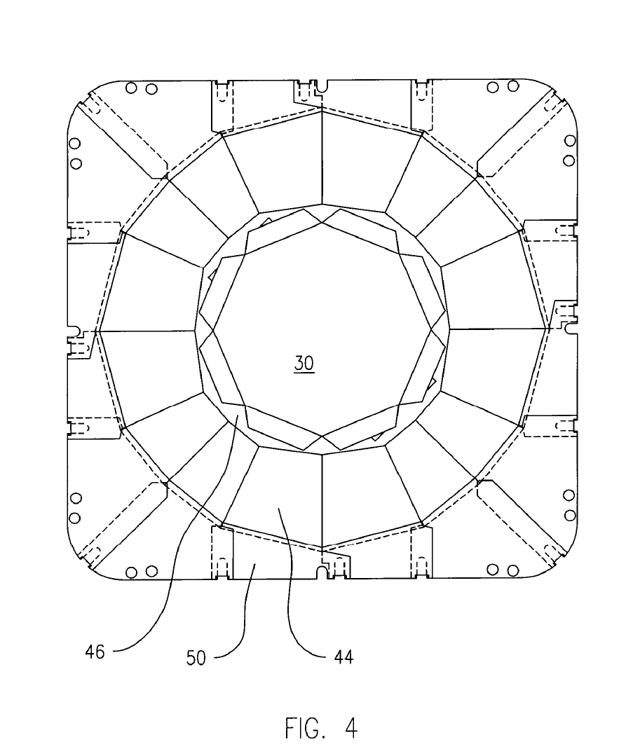

Following joining of panels 44a and 44b, mounting flange 50b is folded outward along fold line 84 into a mounting flange forming position substantially coplanar with the first mounting flange 50a. When fully folded, a side edge of mounting flange 50b overlies an adjacent side edge of mounting flange 50a, as shown in FIGS. 1 and 4. The overlapping side edges are aligned so that the locking tab 70 on mounting flange 50b registers with one of the locking notches 72 on mounting flange 50a. With the side edges aligned in this fashion, the locking tab 70 from mounting flange 50b is bent around and through the notch 72 on mounting flange 50a to secure the two flange portions together.

Following the folding of second panel 44b and mounting flange 50b, the next adjacent panel 44c is similarly shaped and folded so that a free edge of the panel abuts and is secured to the free edge of the previous panel 44b through positioning tabs 62 and tab/slot pairs 64, 66. Similarly, the mounting flange 50c is folded to overlie the previous mounting flange 50b with the locking tab 70 on flange 50c registering with the locking notch 72 on flange 50b. In this position, the locking tab is bent around and through the locking notch to secure the mounting flanges 50b, 50c together.

The remaining panels 44d- 44p are similarly folded and shaped in a continuously curving manner, moving in a counter-clockwise direction, to form the three-dimensional reflector shape. As each of the remaining planar panels 44d-44p is folded into an edge abutting relationship with the previous panel, the panel is shaped, in the manner described above, to form a smooth, continuously-curved, inward concave reflective contour from the collar 46 to the mounting flange 50. After each panel is folded and shaped, the panel is secured to the next previous panel through positioning tabs 62 and locking tabs and slots 64, 66. Similarly, the remaining mounting flanges 50d-50o are each folded outwardly, following the shaping of the attached panel, to engage and lock onto the adjacent mounting flange. Mounting flange 50p of panel 44p is the last flange folded, with the final locking tabs 70 (on mounting flange 50p) registering with the adjacent locking notches 72 on the initial mounting flange 50a and the next previous mounting flange 50o.

It can be appreciated that the panel and flange securement means described herein cooperate upon assembly of reflector 22 to retain a self-standing three-dimensional reflector shape. Those of ordinary skill in the art will appreciate that other locking structures and folding configurations are possible to form and retain the reflector 22 in its self-standing reflector shape without departing from the spirit and scope of the present invention. Likewise, the order in which the panels are folded and secured together can be varied without departing from the scope of the invention. Following the folding and securing together of panels 44a-44p and mounting flange 50a-50p, collar segments 48 are folded along the fold lines formed by slots 56, into the interior of the assembled reflector 22. Preferably, segments 48 are folded back towards the panels 44 at approximately a 135° angle. When folded into the interior of the reflector, segments 48 form a plurality of light diffusing surfaces about the perimeter of light source opening 30. Collar segments 48 prevent light from reflecting from the apex of the reflector straight down through opening 34 and forming hot spots or striations of light on the surface below.

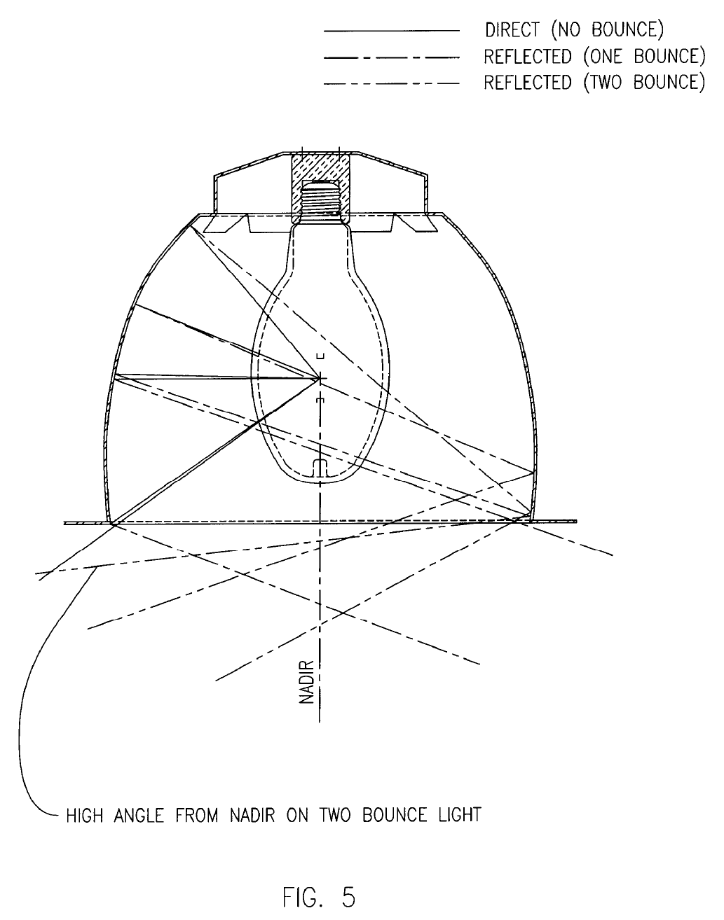

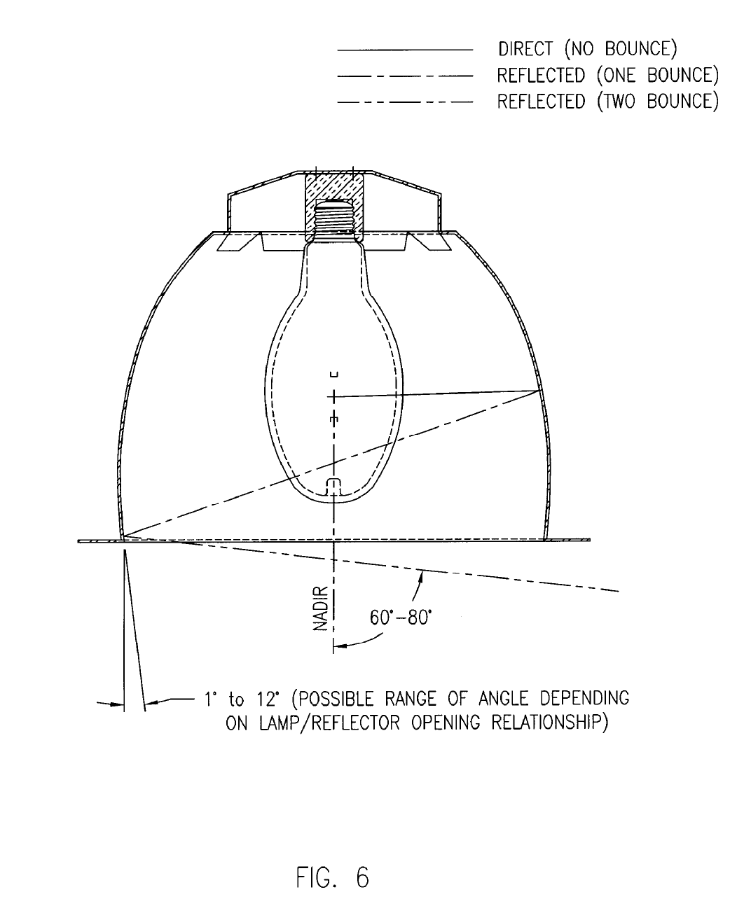

FIGS. 1 and 4 depict a fully assembled reflector following the above folding and shaping process. As shown in these Figures, the assembled, abutting reflective panels 44 form a substantially contiguously arranged curved reflective surface in the interior of reflector 22. When the sixteen continuously curved, planar integrated panels 44a-44p are assembled together, the resulting three-dimensional reflector has a circular paraboloid shape. A cross-section of the reflector 22, taken along a line perpendicular to nadir 42 and parallel to the plane of light emitting opening 34, has a substantially circular configuration. The diameter of the reflector cross-section varies along nadir, with the area of greatest diameter being located just above the toed-in lower edge portion of the reflector. As shown in greater detail in FIGS. 5 and 6, panels 44 are toed-in along the lower edge portion of the reflector to produce a negative angle between the bottom edge of the panel and nadir 42. The bending in of the lower reflector edge causes a gradual reduction in the cross-sectional diameter of the reflector moving in the direction of the light emitting opening. As shown in FIG. 6, optimum performance from reflector 22 is achieved when the angle between the curved-in lower edge of the reflector and a line parallel to nadir is in the range of 1° to 12°. However, it is envisioned that alternative reflector and luminaire sizes and geometries could be developed wherein optimum light reflecting performance could be achieved at angles exceeding 12°, without departing from the scope and intent of the present invention.

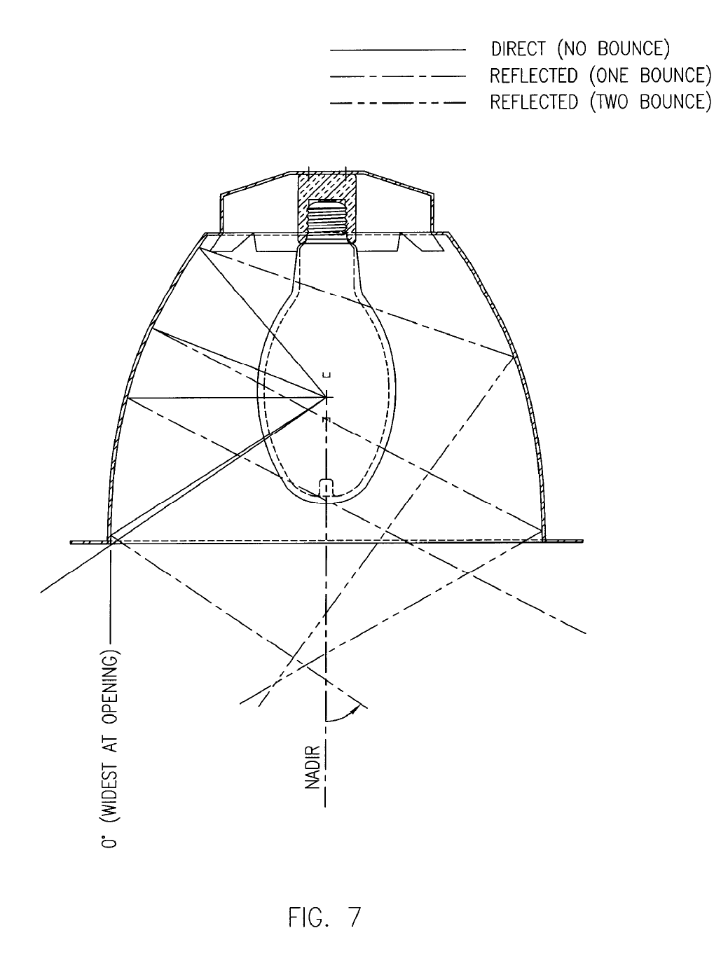

Traditionally, IESNA Type V luminaire reflectors have been designed such that the diameter of the reflector, taken along a line perpendicular to nadir, increases in the direction of the light emitting opening. Typically, as shown in FIG. 7, the reflector increases in diameter so that the reflector has the largest diameter at the light emitting opening, in order to directly emit as much light from the light source as possible, and reduce the quantity of light that is reflected (or bounced) off of the sides of the reflector. Each time a beam of light is reflected within the reflector, a percentage of the energy is lost from the beam. Accordingly, these reflectors have sought to reduce the amount of reflecting light within the reflector, and, thus, the amount of energy loss within the luminaire.

In the reflector of the present invention, however, the lower edge of the reflective panels is curved inwardly towards nadir, in order to reduce the diameter of the reflector at the light emitting opening, and create a secondary reflective surface within the reflector. This secondary reflective surface reflects light that has been initially reflected from the smooth, continuously-curved surfaces in the apex of the reflector, as well as directly reflects light emitted towards the bottom of the reflector, as shown in FIG. 5. In re-reflecting the light rays from the apex of the reflector, the toed-in, lower edge of the reflector creates a secondary reflective surface that redirects the light from the upper hemisphere of the reflector outward at a higher angle from nadir than the light would exit if the widest diameter of the reflector where located at the light emitting opening. As shown in FIG. 6, the toed-in lower edge of the reflector enables light to be reflected at an angle in the range of 60° to 80° with respect to nadir. Previously, Type V reflectors, such as shown in FIG. 7, reflected light at angles of less than 60° with respect to nadir, resulting in a smaller illumination area. Using the toed-in secondary reflective surface to increase the angle at which the light exits the reflector, enables the light to travel a farther distance across the illuminated surface. Thus, the higher exit angle of the light rays from the secondary reflective surface creates a larger area of illumination on the lighted surface.

In the present invention, greater control and redirection of the emitted light is also achieved by raising the level of the light source within the reflector. Raising the light source within the apex of the reflector enables additional light to be reflected off of both the upper, apex reflecting surfaces, as well as the lower, secondary reflective surface, as indicated by the light ray lines in FIG. 5. In the present invention, curving the lower edge portion of the reflector 22 inward also has the advantage of reducing the visibility of the light source 32 from beneath the luminaire 20. Reducing the visibility of the light source from beneath the luminaire helps to reduce the glare produced by the luminaire. The glare is further reduced by raising the position of the light source within the apex of the reflector.

As shown in FIGS. 3 and 4, in the reflector of the present invention, alternate pairs of the integrated panels 44 have differing widths, as can be measured along the fold line 84 between the panels and mounting flanges 50. The differing widths between the panels 44 enables the reflector 22 to distribute the light from the light source 32 in a substantially square distribution pattern. The varying widths of the panels controls the direction of the reflected light to push light into otherwise dark areas, or corners, to better illuminate those areas. By redistributing the light rays, the reflector 22 creates a more uniform, substantially square illumination pattern. In particular, the narrower width panels (44c, 44d, 44g, 44h, 44k, 44l, 44o, and 44p) reflect light into the corners of the squared light pattern (to produce greater illumination in the corners than achieved in a circular symmetric pattern), while the wider width panels (44a, 44b, 44e, 44f, 44i, 4j, 44m, 44n) reflect light along the sides of the distribution pattern. In the preferred embodiment shown, the 16 integrated panels are grouped into pairs of wide reflective panels and narrow reflective panels. The panel pairs are spaced such that the sets of wide panels and sets of narrow panels alternate around the perimeter of the reflector. Accordingly, the three-dimensional reflector comprises four symmetrical quadrants, each comprising a pair of narrow panels adjacent a pair of wide panels. The redistribution of reflected light by the differing width panels, as well as the high angle with nadir obtained with the secondary reflective surface, combine to enable a luminaire with the present inventive reflector to produce a substantially square light pattern.

The luminaire reflector embodiment described above has energy efficiencies over luminaires using conventional Type V reflectors due to the increased spread of the reflected light and the reflection of light into corners to produce a substantially square illumination pattern. Accordingly, the present inventive reflector can be used to obtain an increased area of illumination as from a conventional reflector that produces a circular illumination pattern, while using substantially the same power wattage. Alternatively, the present inventive reflector can be used to illuminate approximately the same size area as a conventional IESNA Type V reflector, while using approximately 33% less power. The energy saving advantages of the present inventive reflector can be observed through comparison of iso-footcandle plots for luminaires using the present inventive reflector and a typical, conventional, IESNA Type V reflector. The iso-footcandle plots in this example were both made using a 120,000 lumen HID lamp in a luminaire assembly mounted at a height of 42 feet.

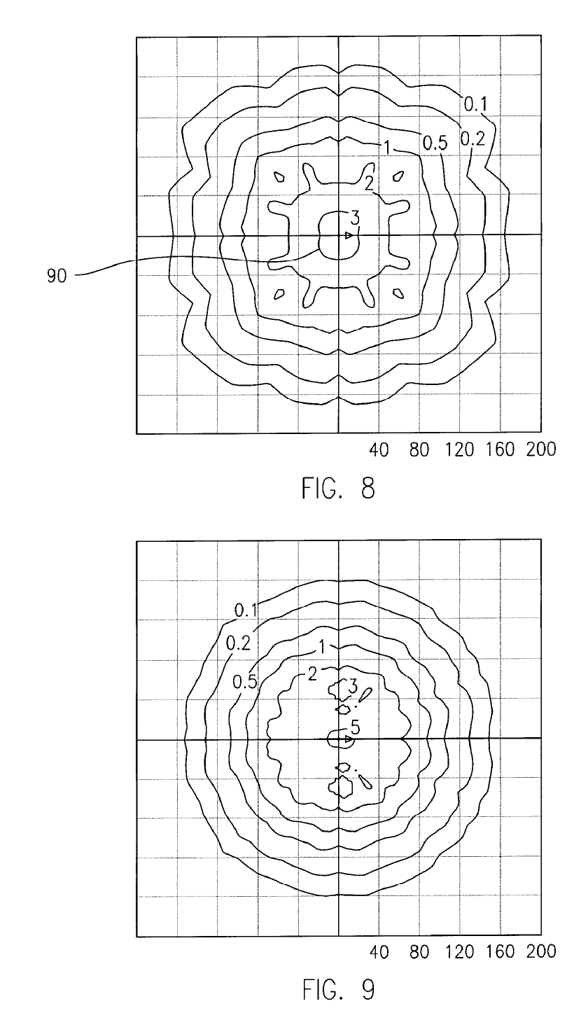

FIG. 8 represents an isolux plot of the horizontal footcandles produced on a planar subject field by a luminaire assembly containing the present inventive reflector. As shown in FIG. 8, the light distribution pattern produced on the surface beneath the luminaire is substantially square, having sides in excess of 120 feet in length. This pattern is obtained by mounting the luminaire so that the plane of the light emitting opening is parallel to the subject field. In this position, nadir for the reflector is substantially perpendicular to both the light emitting opening plane and the subject field, and passes through the center of the pattern. As illustrated, the light pattern includes a central region (defined by peripheral boundary 90) of highest illumination circumscribed by regions of decreasing illumination. In the pattern shown, the central region spans approximately 20 feet and has a foot-candle reading of 3.

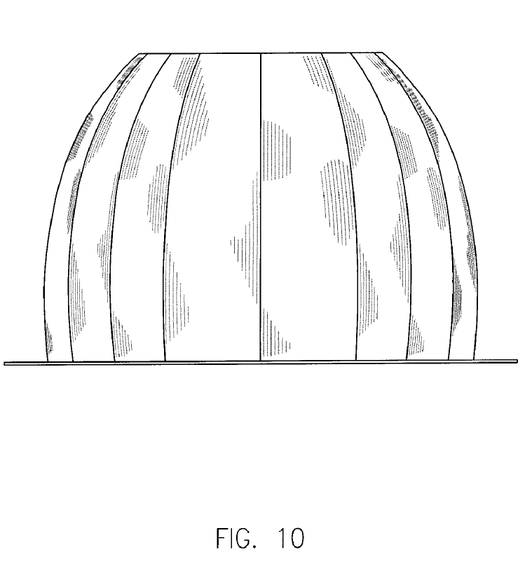

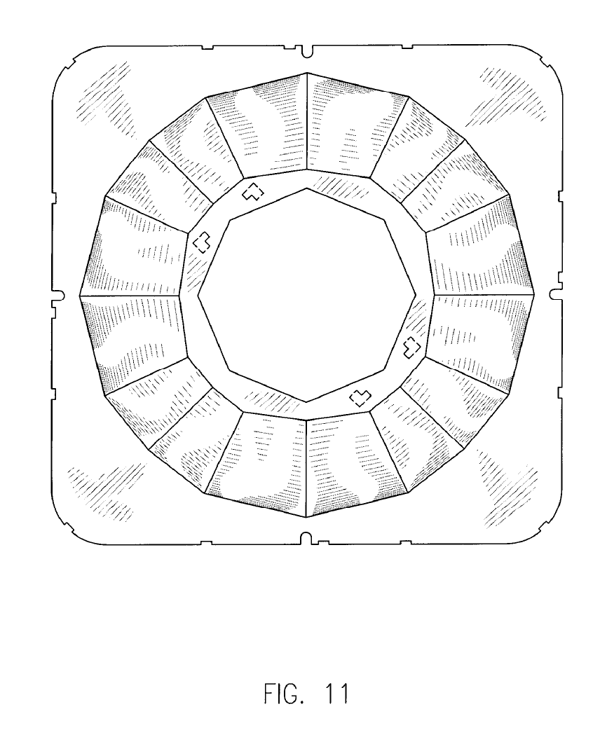

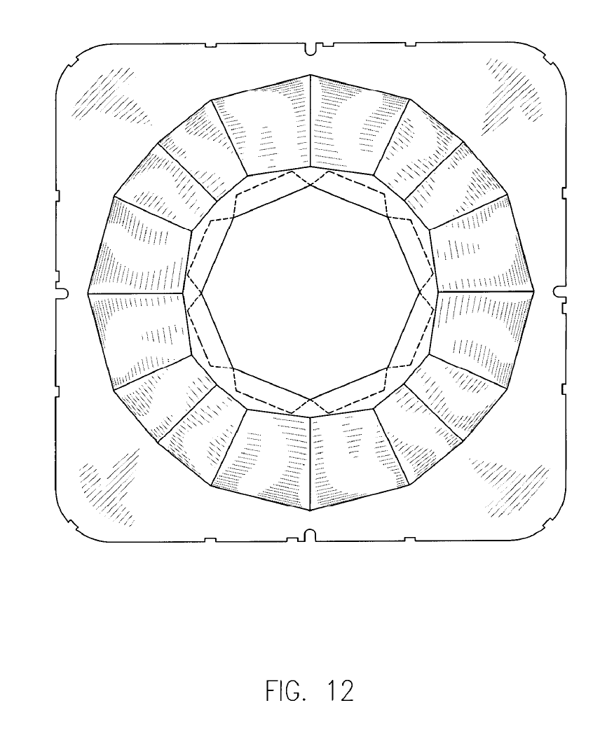

The pattern in FIG. 8 can be compared with an isolux plot for a conventional luminaire reflector, such as shown in FIG. 9. In the FIG. 9 plot, the conventional reflector produces a more circular pattern in which the illumination is essentially the same at all lateral angles around the center of the pattern. With the conventional reflector, the foot candle output in the outer corners of the pattern is reduced to essentially zero. Accordingly, in a wide area application, such as a parking lot, in which it is necessary to maintain a uniform, minimum footcandle level throughout the surface area, additional luminaires having the distribution pattern shown in FIG. 9 would be required to compensate for the “dark corners” left by the circular light distribution pattern. Therefore, as shown by these plots, the luminaire reflector of the present invention produces a substantially square light distribution pattern with a more uniform level of lighting throughout the pattern. The more widespread, uniform pattern of the present invention enables fewer luminaires to be used to obtain a desired lighting level, thereby reducing energy consumption. Alternatively, the same number of luminaires could be utilized, but the light source wattages within each luminaire could be reduced to conserve energy. The light intensity distribution from the reflector of the present invention could easily be modified from that shown in the plot of FIG. 8 by adjusting the mounting height or wattage of the lamp.

While the present invention has been illustrated by a description of various embodiments, and while these embodiments have been described in considerable detail, it is not the intention of the applicant to restrict or in any way limit the scope of the appended claims to such detail. The size of the reflector, as well as the placement of the light source within the reflector, may be varied depending upon the particular lighting level and illumination pattern sought to be achieved. Furthermore, the reflector has been described as having 16 planar reflective panels. However, many of the features of the present invention can be achieved with a reflector having a different number of panels. Additional advantages and modifications will readily appear to those skilled in the art. The invention in its broadest aspects is, therefore, not limited to the specific details, representative apparatus and illustrative examples shown and described. Accordingly, departures may be made from such details without departing from the spirit or scope of applicant's general inventive concept.

What is claimed is:

1. A reflector for a luminaire that has a light source securable therein, said reflector comprising:
a plurality of reflective panels retained in a three-dimensional, inward, concave reflector shape, said reflector shape defining a first opening for the light source and a second opening for emitting light in a predetermined distribution pattern, each of said reflective panels having an inwardly-facing smooth reflective surface between the light source opening and the light emitting opening, said light emitting opening extending in a plane perpendicular to nadir, and said reflective panels being curved inward towards nadir between a maximum reflector diameter and the light emitting opening; and
means for positioning the light source within an apex of the reflector.

2. The reflector of claim 1, wherein the three-dimensional reflector shape is substantially circular in cross-section.

3. The reflector of claim 1, wherein said three-dimensional concave reflector shape is a circular paraboloid.

4. The reflector of claim 1, wherein said plurality of reflective panels are folded along fold lines in an abutting relationship.

5. The reflector of claim 1, wherein said predetermined light distribution pattern is substantially square.

6. The reflector of claim 1, wherein a longitudinal axis of said light source is aligned vertically with nadir.

7. The reflector of claim 1, wherein the inward curve of said reflective panels forms a secondary reflective surface adjacent said light emitting opening.

8. The reflector of claim 7, wherein a portion of light from said light source is reflected twice within said reflector prior to passing through said light emitting opening.

9. The reflector of claim 8, wherein said twice reflected portion of light is reflected in the apex and secondary reflective surfaces of the reflector.

10. The reflector of claim 8, wherein said twice reflected portion of light passes through said light emitting opening at a high angle from nadir.

11. The reflector of claim 10, wherein the angle between said twice reflected portion of light and nadir is at least 60 degrees.

12. The reflector of claim 1, wherein said three-dimensional reflector shape comprises 16 interconnected reflective panels.

13. The reflector of claim 12, wherein at least two of said reflective panels have differing widths.

14. The reflector of claim 13, wherein said plurality of reflective panels are connected within said three-dimensional reflector shape in pairs of differing widths.

15. A luminaire assembly comprising:
a luminaire housing;
a reflector mounted within the luminaire housing, said reflector comprising a plurality of reflective panels retained in a three-dimensional inward concave reflector shape, said reflector shape defining a light source opening and a light emitting opening for emitting light in a predetermined distribution pattern, said light emitting opening occupying a plane perpendicular to nadir, said reflective panels being curved inward towards nadir between a maximum reflector diameter and said light emitting opening to form a reduced diameter at the light emitting opening;
a light source socket mounted to the reflector; and
a light source attached within said socket for emitting light upon energizing said source, said light socket mounted so as to position the light source within an apex of said reflector.

16. The luminaire assembly of claim 15, wherein said plurality of reflective panels are folded along fold lines into an abutting relationship to form a circular paraboloid reflector shape.

17. The luminaire assembly of claim 15, wherein said emitted light forms a substantially square light distribution pattern.

18. The luminaire assembly of claim 15, wherein at least two of said plurality of reflective panels have differing widths, and said substantially square light distribution pattern is formed by reflecting light from said differing width panels.

19. The luminaire assembly of claim 15, wherein at least a portion of the light emitted from said light source is reflected in said reflector apex and in a lower, inwardly curved portion of the reflector prior to passing through said light emitting opening.

20. A method of obtaining an increased area of illumination from an energy-efficient, light directing reflector luminaire as from a conventional reflector luminaire, when the luminaires have substantially the same wattage light sources and are mounted on poles at substantially the same mounting height, the method comprising the steps of:
providing a conventional reflector luminaire which emits a symmetrical, circular illumination pattern;
providing an energy-efficient, light directing reflector luminaire comprising a reflector having a plurality of inner reflector panels retained in a three-dimensional, inward concave, reflector shape, said reflector shape defining a first opening for a light source and a second opening for emitting light in a substantially square distribution pattern, each of said reflective panels having an inwardly-facing smooth reflective surface between the light source opening and the light emitting opening, and wherein said reflective panels are curved inward towards nadir between a maximum reflector diameter and the light emitting opening; and
replacing the conventional reflector luminaire with the energy-efficient light directing reflector luminaire, to produce a larger illumination area having a substantially square illumination pattern, thereby enabling the luminaire mounting poles to be spaced a greater distance apart.
